(19) United States
(12) Patent Application Publication
(10) Pub. No.: US 2017/0371069 A1
(43) Pub. Date: Dec. 28, 2017

(54) FIBER OPTIC STREAMER MONITORING

(71) Applicant: PGS Geophysical AS, Oslo (NO)

(72) Inventor: Michael MALLING, Oslo (NO)

(21) Appl. No.: 15/491,765

(22) Filed: Apr. 19, 2017

Related U.S. Application Data
(60) Provisional application No. 62/354,435, filed on Jun. 24, 2016.

(51) Int. Cl. G01V 13/00; G01V 1/22; G01D 5/353; G01K 11/32; G01V 1/38; G01V 1/24

(52) U.S. Cl. CPC G01V 13/00; G01V 1/3808; G01V 1/24; G01D 5/35316; G01K 11/3206; G01V 1/226

(57) ABSTRACT

A method includes collecting spectral data from fiber Bragg grating sensors distributed at locations along a fiber optic component positioned along a streamer; and analyzing the spectral data to produce measurements of bend of an axis of the streamer proximate the locations. A streamer monitoring system includes: a fiber optic component positioned along a streamer; a plurality of fiber Bragg grating sensors distributed at locations along the fiber optic component; a light source optically coupled to the fiber optic component and configured to interrogate the fiber Bragg grating sensors; a photodetector optically coupled to the fiber optic component and configured to collect spectral data from the interrogated fiber Bragg grating sensors; and a spectral analyzer in communication with the photodetector and configured to analyze the spectral data to produce measurements of bend of an axis of the streamer proximate the locations along the fiber optic component.

### CROSS REFERENCE TO RELATED APPLICATIONS

This application claims benefit of U.S. Provisional Patent Application Ser. No. 62/354,435, filed Jun. 24, 2016, entitled “Fiber Optic Streamer Monitoring,” which is incorporated herein by reference.

### BACKGROUND OF THE INVENTION

This disclosure is related generally to the field of marine surveying. Marine surveying can include, for example, seismic and/or electromagnetic surveying, among others. For example, this disclosure may have applications in marine surveying in which one or more sources are used to generate energy (e.g., wavefields, pulses, signals), and geophysical sensors—either towed or ocean bottom—receive energy generated by the sources and possibly affected by interaction with subsurface formations. Towed sensors may be disposed on cable or cable assemblies referred to as streamers. Some marine surveys locate geophysical sensors on ocean bottom cables or nodes in addition to, or instead of, streamers. The geophysical sensors thereby collect geophysical data which can be useful in the discovery and/or extraction of hydrocarbons from subsurface formations.

Current marine survey techniques may utilize multiple streamers, towed at multiple depths, and towed at selected lateral distances from one another. The streamers may be 5-10 kilometers long, or longer. Accurate survey results depend on accurate knowledge of the distance between the source and each of the geophysical sensors on each streamer. Streamers may be subject to vessel motions and wake, water currents and waves, and other forces that cause elongation, bending, twisting, or fanning of the streamers. Therefore, accurately identifying the distance of each geophysical sensor from the source at the time of each survey measurement is challenging. In addition to data integrity concerns, the shape of a streamer profile and the location of each portion of a streamer may be of significance to survey operations. For example, a highly deviated streamer may create excess drag; streamers too close together or close to other survey vessels or equipment may risk entanglement; and a kinked streamer may foretell impending equipment failure. The tension on each portion of a streamer may also provide useful information, such as whether an increase in towing speed could be tolerated. Conventional strain measurements are typically made with sensors that are placed several-inches to several-feet apart. The conventional sensors each require a connection point (such as solder) onto the structure, and an individual set of wire feeds for power and signal communication. Therefore, conventional strain measurement equipment tends to be bulky, heavy, and tends compromise the smoothness of the surface being measured. The pressure on each portion of a streamer may also provide useful information, such as water depth. Geophysical survey operations would benefit from streamer monitoring that provides more precise information in near-real time about a variety of streamer characteristics, while not adding excessive weight or drag to the survey equipment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1E are illustrations of characteristics of a fiber Bragg grating structure.

FIG. 2 is an illustration of a Michelson interferometer.

FIG. 3 is an illustration of a geophysical survey system.

FIGS. 4A-4C illustrate various configurations of a fiber optic component positioned along a streamer.

FIG. 5 illustrates a streamer monitoring system.

FIG. 6 illustrates fiber Bragg grating sensors distributed throughout a cross-section of a streamer.

FIG. 7 illustrates operational usage of fiber Bragg grating sensors in streamers of geophysical survey systems.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +−10% variation. The term “nominal” means as planned or designed in the absence of variables such as wind, waves, currents, or other unplanned phenomena. “Nominal” may be implied as commonly used in the field of marine surveying.

“Cable” shall mean a flexible, axial load carrying member that also comprises electrical conductors and/or optical conductors for carrying electrical power and/or signals between components. The word “cable” is also used herein to refer to assemblies of cables that may be wrapped, gathered, or otherwise physically associated into a cable-like collection of individual cables.

“Rope” shall mean a flexible, axial load carrying member that does not include electrical and/or optical conductors. Such a rope may be made from fiber, steel, other high strength material, chain, or combinations of such materials.

“Line” shall mean either a rope or a cable.

“Optical fiber” shall mean a flexible fiber capable of transmitting light between the two ends of the fiber. An optical fiber may be made up of multiple segments, joined end-to-end, each segment itself being a flexible fiber capable of transmitting light signals between the two ends of the segment. As such, segments may be joined by passive splices that transmit light from one segment to the next, or by active splices that amplify or modulate light from one segment to the next.

“Optical fiber bundle” shall mean a plurality of optical fibers in close radial proximity and generally spanning the same end-to-end axial path. The optical fibers of a bundle may be in contact with one another. The optical fibers of a bundle may be wrapped around one another, or around another piece of equipment that generally spans the same end-to-end axial path. The optical fibers of a bundle may be secured together to reduce relative motion between one another.

“Fiber optic component” shall mean an optical fiber, an optical fiber bundle, or a part thereof.

“Forward” or “front” shall mean the direction or end of an object or system that corresponds to the intended primary direction of travel of the object or system.

“Aft” or “back” shall mean the direction or end of an object or system that corresponds to the reverse of the intended primary direction of travel of the object or system.

“Obtaining” data shall mean any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

The term “near-real time” refers to the time delay resulting from detecting, sensing, collecting, filtering, amplifying, modulating, processing, and/or transmitting relevant data or attributes from one point (e.g., an event detection/sensing location) to another (e.g., a data monitoring location). In some situations, a time delay from detection of a physical event to observance of the data representing the physical event is insignificant or imperceptible, such that near-real time approximates real time. Near-real time also refers to longer time delays that are still short enough to allow timely use of the data to monitor, control, adjust, or otherwise impact subsequent detections of such physical events.

If there is any conflict in the usages of a word or term in this specification and one or more patent or other documents that may be incorporated herein by reference, the definitions that are consistent with this specification should be adopted for the purposes of understanding this invention.

The present invention generally relates to marine surveying methods and apparatuses, and, at least in some embodiments, to novel streamers having fiber optic components, and their associated methods of use.

In accordance with at least some embodiments of the present disclosure, damage to streamers from tension may be reduced. For instance, detection of a change in tension along the length of a streamer may be indicative of debris caught in the streamer, barnacle growth, and/or other factors that increase drag. Additionally, at least one embodiment can reduce tangling of streamers because the streamer shape may be identified over the length of the streamer, as well as over all of the streamers in a spread.

In accordance with at least some embodiments of the present disclosure, data quality may be increased because the streamer shape may be known over much or all of the length of a streamer, and over many or all of the streamers in a spread, at multiple times throughout the survey. Additionally, a speed of towing the spread may be increased because forces active on the streamer may be known and updated, meaning estimates are not needed. In at least one embodiment, the streamer monitoring system can provide input to a navigation solution associated with streamers and/or a vessel towing the streamers.

Also in accordance with at least some embodiments of the present disclosure, data for modeling and/or data processing may be improved. For example, near-real time measurements of temperature may be of interest to ancillary marine survey equipment. Modeling that includes estimations of the density of the sea water may be improved with improved temperature measurements.

At least one embodiment of the present disclosure can include a geophysical survey system including one or more streamers and a streamer monitoring system to monitor the one or more streamers. The streamer monitoring system can include a fiber optic component in or on a streamer, and the fiber optic component can include Fiber Bragg Grating (“FBG”) sensors. The streamer monitoring system can include one or more interferometers. In at least one embodiment, the FBG sensors can be multiplexed serially along the fiber optic component. The fiber optic component can be embedded in a portion of, and/or an entire length of, the streamer (e.g., the fiber optic component may be located within a jacket of the streamer).

The streamer monitoring system can monitor the streamer in near-real time and can provide a user with near-real time streamer characteristic data. In an embodiment, the streamer monitoring system may gather data in near-real time, such as spectral data from interrogated FBG sensors, measurements of elongation of a streamer in the axial direction, measurements of bending of an axis of a streamer, measurements of twisting of a streamer about its axis, and/or temperature data from fiber optic distributed temperature sensing (FDTS) sensors. In an embodiment, the streamer monitoring system may determine physical characteristics of at least a portion of a streamer in near-real time, such as elongation, bend, twist, strain, shape, load, curvature, deformation, temperature, tension, torsion, profile shape (in one, two, or three dimensions), stress, pressure, strength, stiffness, and/or operational loads. For example, FBG sensors may be distributed along and/or throughout the streamer to form a FBG sensor array for measuring shape (deflection or strain) at multiple locations on the streamer. The FBG sensor array may include numerous FBG sensors, which may be distributed at regular or irregular intervals along the streamer. A multi-core optical fiber may be used, thereby permitting three or more channels in a single optical fiber. An FBG sensor array along a multi-core optical fiber may identify, detect, and/or monitor data reflective of deformation of the optical fiber in one, two, or three dimensions. For example, a FBG sensor strain measurement may be proportional to the bend radius and the position of the FBG sensor relative to the bend. Likewise, FBG sensor strain measurements form multiple cores in a multi-core optical fiber may indicate the direction and amount of bend in the optical fiber. Data from each FBG sensor may be individually identified, detected, and/or monitored by way of modal filtering.

Embodiments of the present disclosure can thereby be useful in the discovery and/or extraction of hydrocarbons from subsurface formations.

At least one embodiment of the present disclosure includes a fiber optic streamer monitoring system to determine various physical characteristics of at least a portion of a streamer. For example, the streamer monitoring system may monitor, at various points along the streamer, elongation, bend, twist, strain, shape, load, curvature, deformation, temperature, tension, torsion, profile shape (in one, two, or three dimensions), stress, pressure, strength, stiffness, and/or operational loads in real time or near-real time, with the use of a fiber optic component positioned along at least a portion of the length of the streamer. The fiber optic component may be located inside the streamer or external to the streamer, and the fiber optic component may be an optical fiber and/or an optical fiber bundle.

In at least one embodiment, FBG sensors can be used together with an interferometer technique. For example, an interferometer may simultaneously monitor many (e.g., thousands) of FBG sensors in a single optical fiber to gather data in near-real time, such as spectral data from interrogated FBG sensors, measurements of elongation of a streamer in the axial direction, measurements of bending of an axis of a streamer, and/or measurements of twisting of a streamer about its axis.

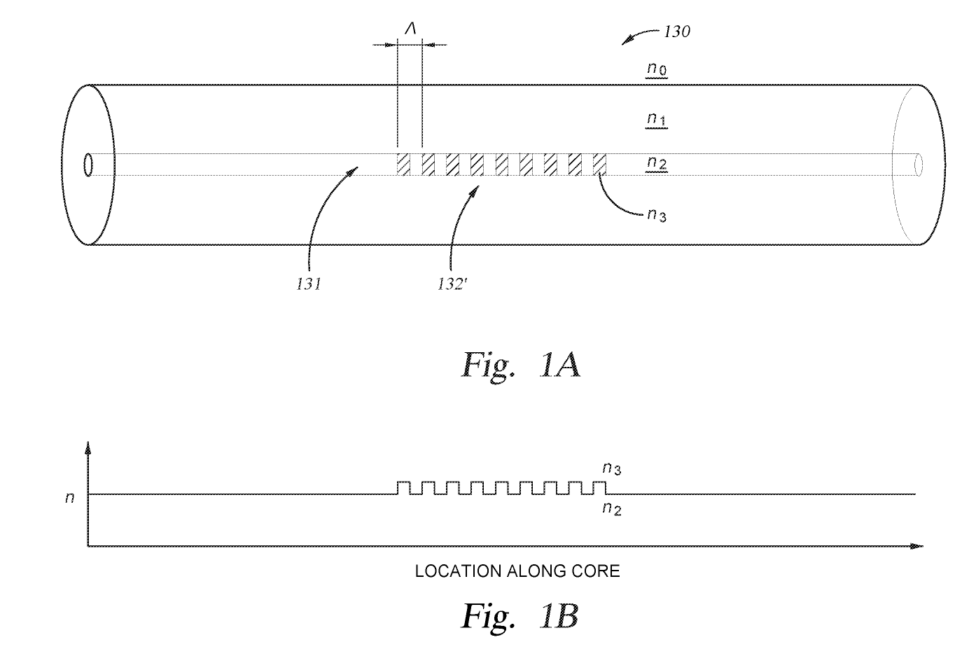

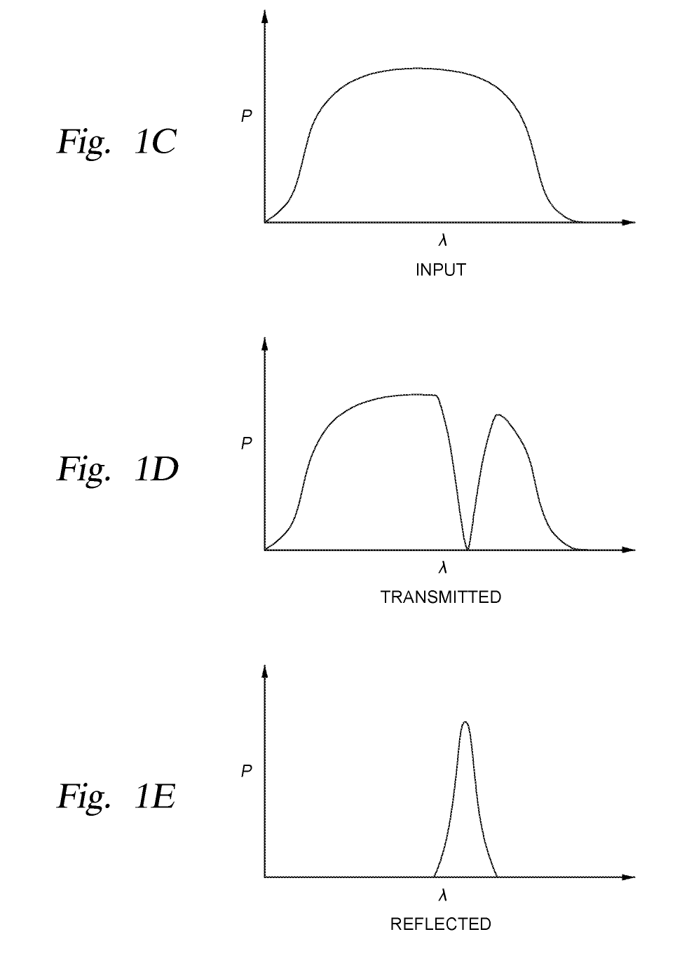

As seen in FIG. 1A, an FBG structure 132′ is generally a type of distributed Bragg reflector, constructed in a segment of fiber optic component 130, and that reflects particular wavelengths of light and transmits all others. This can be achieved by creating a periodic variation (having grating period Λ) in the refractive index n of the fiber core 131, which generates a wavelength-specific dielectric mirror. An FBG structure 132′ can therefore be used as an in-line optical filter to block certain wavelengths, or as a wavelength-specific reflector. FIG. 1B illustrates a refractive index profile of the example FBG structure 132′ from FIG. 1A. With this example, when an input broadband light such as shown in FIG. 1C encounters the FBG structure 132′ of FIG. 1A, certain wavelengths of light are transmitted, as shown in FIG. 1D, while other wavelengths of light are reflected, as shown in FIG. 1E.

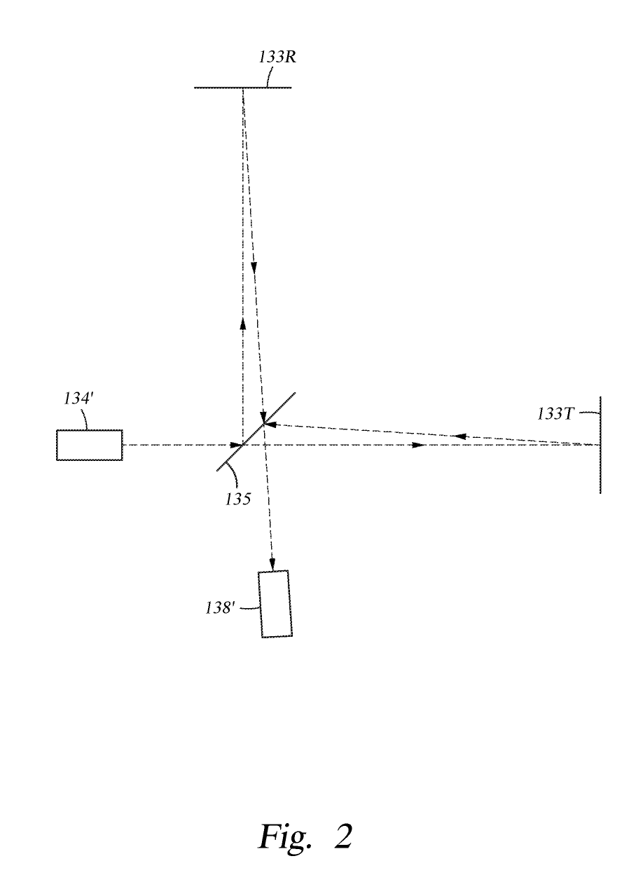

Interferometry is a family of techniques in which waves, usually electromagnetic, are superimposed in order to extract information about the waves. Interferometers can be used for the measurement of small displacements, refractive index changes, and surface irregularities. Interferometers can also be used in continuous wave Fourier transform spectroscopy to analyze light containing features of absorption or emission associated with a substance or mixture. FIG. 2 illustrates a light path through a Michelson interferometer. A coherent light source 134′ generates light which is partially transmitted and partially reflected by a half-silvered mirror 135. The transmitted light is reflected at mirror 133T, while the reflected light is again reflected at mirror 133R. The two light rays combine at the half-silvered mirror to reach the detector 138′. The two light rays can either interfere constructively (strengthening in intensity) if their light waves arrive in phase, or interfere destructively (weakening in intensity) if they arrive out of phase, depending on the distances between the three mirrors.

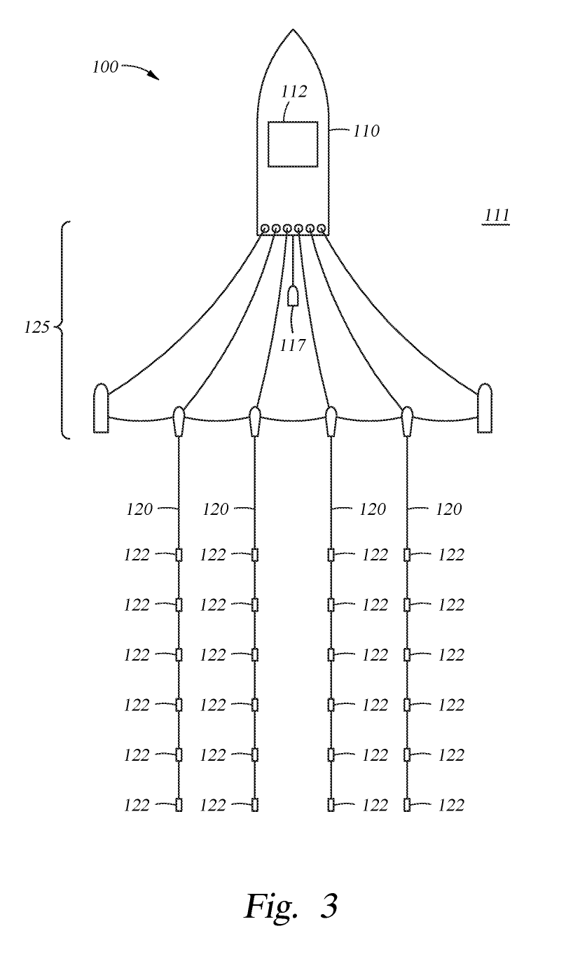

FIG. 3 shows a geophysical survey system 100 that may include one, or a plurality of, streamers 120. The illustrated geophysical survey system 100 includes a survey vessel 110 that moves along the surface of a body of water 111 such as a lake or an ocean. The survey vessel 110 may include thereon equipment, shown generally at 112 and for convenience collectively referred to as a “recording system.” The recording system 112 typically includes devices such as a data recording unit (not shown separately) for making a record with respect to time of energy detected by various sensors, explained below. The recording system 112 also may include navigation equipment (not shown separately) to monitor, record, and/or control, at selected times, the position and speed of the vessel 110, geophysical sensors 122, streamers 120, and other equipment of the geophysical survey system 100.

The geophysical sensors 122 can be any combination of any type of geophysical sensor known in the art. Non-limiting examples of such sensors may include particle motion-responsive seismic sensors such as geophones and accelerometers, pressure-responsive seismic sensors, pressure time gradient-responsive seismic sensors, electromagnetic sensors such as electrodes, magnetometers, and environmental sensors such as temperature sensors or combinations of any of the foregoing. The geophysical sensors may detect, measure, or receive energy (e.g., wavefields, pulses, signals) generated by one or more sources 117 and possibly affected by interaction with subsurface formations. The source 117 may be towed in the water 111 by the survey vessel 110 or a different vessel (not shown). The recording system 112 may also include source control equipment (not shown separately) for actuating the source 117 at selected times.

The illustrated geophysical survey system 100 includes four laterally spaced apart streamers 120 towed by the survey vessel 110. The number of streamers shown in FIG. 3, however, is only a representative example and is not a limitation on the number of streamers that may be used in any particular system or method according to the invention. In geophysical survey systems such as shown in FIG. 3 that include a plurality of laterally spaced apart streamers, the streamers 120 are typically coupled to towing equipment 125 that secures the forward end of each of the streamers 120 at a selected lateral position with respect to adjacent streamers and with respect to the survey vessel 110. “Lateral” in the present context means transverse to the direction of motion of the survey vessel 110 in the water 111. In some embodiments, towing equipment 125 may include or carry equipment capable of communicating signals between the streamers 120 and the recording system 112. For example, the towing equipment 125 may include or carry electrical wires or optical fibers for communicating signals between the streamers 120 and the recording system 112. In some embodiments, the equipment capable of communicating between the streamers 120 and the recording system 112 provides a communication channel therebetween. In some embodiments, the communication channel is a fiber optic component. The type of towing equipment 125 shown in FIG. 3 is only intended to illustrate a type of equipment that can tow an array of laterally spaced apart streamers in the water. Other towing structures may be used in other examples of geophysical survey systems according to the invention.

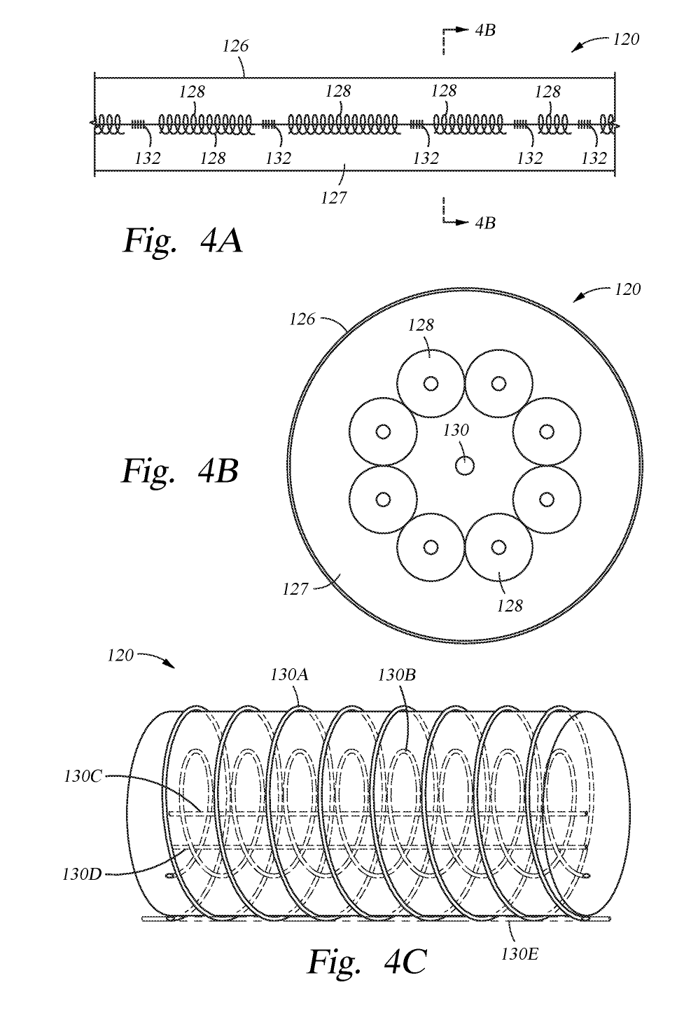

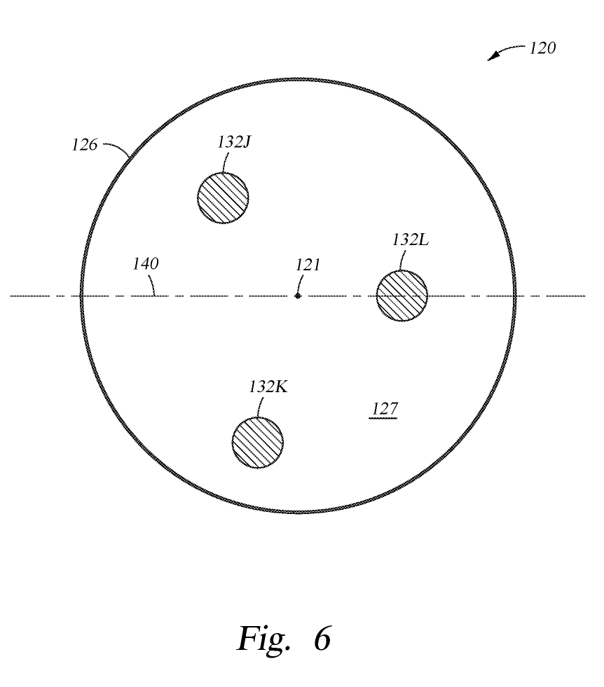

Each streamer 120 may include thereon or therein one or more fiber optic components. For example, as illustrated in FIGS. 4A and 4B, a fiber optic component 130 may be located at the center of the core of streamer 120. Streamer 120 may include one or more layers and a variety of segments, devices, and equipment. The streamer 120 illustrated in FIGS. 4A and 4B has a jacket 126, buoyancy fill material 127, and core equipment 128. As illustrated, core equipment 128 may include a plurality of insulated electrical conductors and/or optical fibers to carry power or communication between the recording system (112 in FIG. 3) and various streamer components. The various elements of the core equipment 128 may be helically wound so that elongation of the streamer 120 in the axial direction does not produce substantial corresponding axial strain in the core equipment 128. Streamer 120 may also have internal or external load-bearing members (not shown). Locating the fiber optic component 130 in the center of the core of streamer 120 (e.g., at the axis 121 of the streamer 120 in FIG. 6) may reduce the risk of damage to the fiber optic component 130 during handling, deployment and use, and to reduce the effect of any torque on the streamer 120 that may change the length of the fiber optic component 130 independent of changes to the length of the streamer 120. In other embodiments, fiber optic component 130 may be located within the streamer 120 (for example, within jacket 126), though not at the center of the core of streamer 120. In other embodiments, particularly with retrofit equipment, fiber optic component 130 may be located on the surface of the streamer 120 (for example, outside of jacket 126). Fiber optic component 130 may span the length of the streamer 120. Since a streamer 120 may be made up of segments, fiber optic component 130 may also be made up of segments. In some embodiments, a segment of fiber optic component 130 may be between about 25 m and about 100 m long. In some embodiments, a segment of fiber optic component 130 may be about 75 m long. In some embodiments, additional fiber optic components 130 may be disposed in or on a streamer 120 to provide redundancy to the system.

Fiber optic component 130 may be positioned along streamer 120 in a variety of configurations. FIG. 4C provides an illustration of several different possible configurations. Fiber optic component 130A is wound around streamer 120 at the exterior surface of streamer 120. Fiber optic component 130A may be wound immediately inside jacket 126, or it may be wound immediately outside of jacket 126. By winding fiber optic component 130A around streamer 120, FBG sensors 132 may be located more closely together in the axial direction than would be possible with a fiber optic component having a parallel axis with streamer 120. The windings of fiber optic component 130A may be evenly spaced along streamer 120, or they may be unevenly spaced, and at some points the windings may overlap and/or reverse directions along the length of streamer 120.

In other embodiments, fiber optic component 130B may be wound around internal components of streamer 120. For example, fiber optic component 130B may be wound around core equipment 128 (shown in FIG. 4B). Fiber optic component 130B may also be disposed within the buoyancy fill material 127 as the streamer 120 is constructed (e.g., extruded). As with fiber optic component 130A, winding fiber optic component 130B along the axis of streamer 120 may allow for closer positioning in the axial direction of FBG sensors 132 than would be possible with a fiber optic component having a parallel axis with streamer 120. Disposing fiber optic component 130B within streamer 120 may provide greater protection to the fiber optic component 130B. The windings of fiber optic component 130B may be evenly spaced along streamer 120, or they may be unevenly spaced, and at some points the windings may overlap and/or reverse directions along the length of streamer 120.

As previously discussed with reference to FIGS. 4A and 4B, in some embodiments fiber optic component 130C may be located at the core of streamer 120. In some embodiments, fiber optic component 130C may be coaxial with streamer 120, while in some embodiments fiber optic component 130C may have small windings close to the axis of streamer 120.

In other embodiments, fiber optic component 130D may be located between the core of streamer 120 and the jacket 126. As with fiber optic component 130C, the axis of fiber optic component 130D may be parallel with the axis of streamer 120, while in some embodiments fiber optic component 130D may have small windings. Fiber optic component 130D may be disposed within the buoyancy fill material 127 as the streamer 120 is constructed (e.g., extruded).

In still other embodiments, fiber optic component 130E may be located at the exterior surface of streamer 120. Fiber optic component 130E may be immediately inside jacket 126, or it may be immediately outside of jacket 126. As with fiber optic component 130C, the axis of fiber optic component 130E may be parallel with the axis of streamer 120, while in some embodiments fiber optic component 130E may have small windings.

Fiber optic component 130 may be positioned along streamer 120 in a variety of other configurations to serve various operational purposes.

As illustrated in FIG. 4A, fiber optic component 130 may have a plurality of axially distributed optical sensors. An optical sensor may be, for example, a FBG sensor 132 etched into the fiber optic component 130. Optical sensors used as strain sensors for towing equipment (e.g., towing equipment 125 in FIG. 3) for marine geophysical survey systems are explained in U.S. Pat. No. 7,221,619 issued to George. The optical sensors may be distributed at equal spacing along the length of the fiber optic component. For example, adjacent optical sensors may be separated by between about 0.15 and about 0.30 inch along fiber optic component. In some embodiments, the separation between adjacent optical sensors may be as little as about 1/16 inch, and as much as about 1 m. In some embodiments, the optical sensors may be distributed by up to about 25 m apart. Separation between the optical sensors determines the granularity of measurement of the streamer shape and position. There is no real limitation on the spacing of optical sensors, and the spacing is selected according to the needs of individual embodiments. The separation between adjacent optical sensors may vary. In some embodiments, the separation will decrease as the distance from the front of the streamer increases. This may allow for additional information from the optical sensors in those areas of the streamer that are most likely to be displaced. In some embodiments, the separation between adjacent optical sensors may increase as the distance from the front of the streamer increases. In some embodiments, the optical sensors may be irregularly spaced.

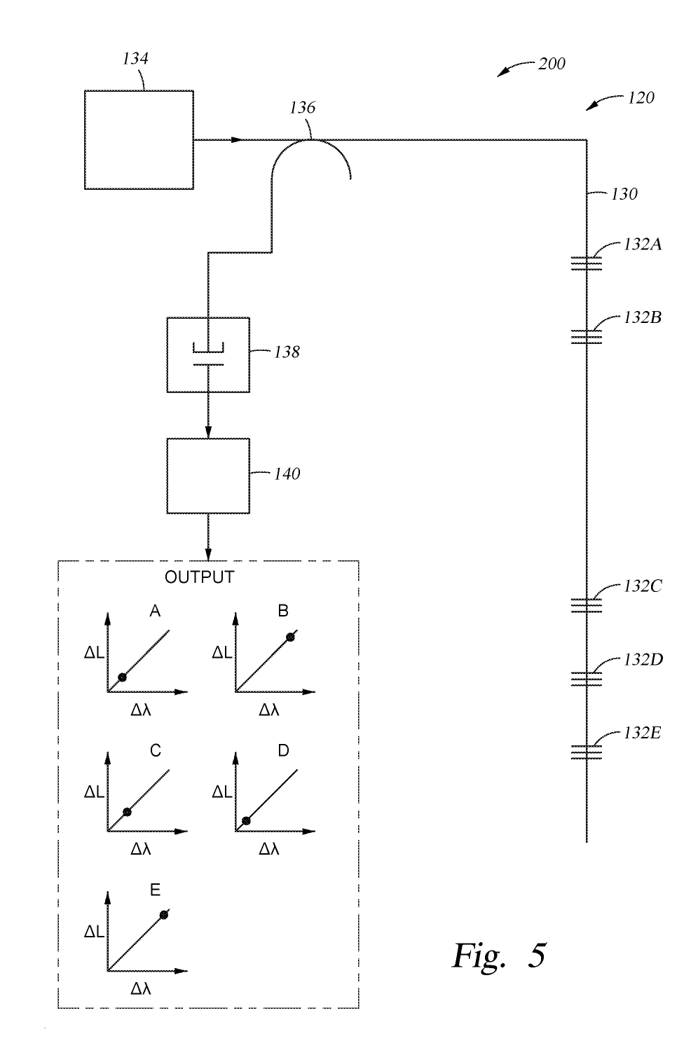

Fiber optic component 130 may be used to measure and/or monitor elongation, bend, and twist at different points along streamer 120. As shown schematically in FIG. 5, a streamer monitoring system 200 may include a fiber optic component 130 and a plurality of axially distributed optical sensors in the form of FBG sensors 132A, 132B, 132C, 132D, 132E, etched into the fiber optic component 130 at selected axial locations. The axial locations may be evenly or unevenly distributed along the streamer 120. In some embodiments, the FBG sensors 132 may be concentrated at locations of higher interest. The fiber optic component 130 may be disposed within or on the outer surface of one of the streamers 120. A light source 134, such as a broadband light source and/or a laser diode, may be disposed in or near the recording system (112 in FIG. 3) or other convenient location, such as on the vessel (110 in FIG. 3). The light source 134 applies broadband coherent light to one input of an optical coupling 136. One output of the optical coupling 136 may be coupled to one end of a fiber optic component 130. The broadband light travels along the fiber optic component 130. At each FBG sensor 132A, 132B, 132C, 132D, 132E on the fiber optic component 130, some of the broadband light is backscattered along the fiber optic component 130. The wavelength of the light backscattered by each FBG sensor 132 will be related to the periodicity of each FBG sensor 132. Each FBG sensor 132 preferably has a different periodicity from the other FBG sensors 132 under at-rest (no elongation, bend, and twist) conditions, and such periodicities are preferably sufficiently different from each other that the backscattered light may be individually identified with respect to each FBG sensor 132 under any tension applied to the streamer 120.

As the streamer 120 is elongated under axial tension, the FBG sensors 132A, 132B, 132C, 132D, 132E will be correspondingly elongated, thus changing the periodicity of each FBG sensor 132 by changing the spacing between the elements of the grating. As a result, the wavelength of light that is backscattered by each FBG sensor 132 will be correspondingly changed. Thus, a measurement corresponding to the elongation of the streamer 120 in the axial direction may be made at one or more individual axial positions by measuring wavelength of the backscattered light.

In the present example, a photodetector 138 may be coupled to one input of the optical coupling 136 to detect the backscattered light from the fiber optic component 130. The photodetector 138 and light source 134 may form part of or be disposed in the recording system (112 in FIG. 3). The output of the photodetector 138 may be coupled to a spectral analyzer 140 (which may also form part of or be associated with the recording system 112 in FIG. 3) so that the wavelengths of the backscattered light may be monitored. As shown in the graphs in FIG. 5, at A, B, C, D, E, each corresponding to a respective FBG 132A, 132B, 132C, 132D, 132E, change in wavelength of the backscattered light, shown on the coordinate axes as Δλ corresponds to elongation of the streamer in the axial direction proximate each FBG 132, shown as a measurement of ΔL along each vertical axis. Generally, elongation in the axial direction will be linearly related to change in wavelength of the backscattered light, however it will be appreciated by those skilled in the art that any other relationship therebetween may be readily characterized. For example, the elongation in the axial direction may be related to the elastic properties of the streamer and the amount of tension at each longitudinal position along the streamer. The elongation of the streamer 120 in the axial direction may cause corresponding change in longitudinal position of each geophysical sensor (122 in FIG. 3) with respect to the survey vessel (110 in FIG. 3). Such position information may be used to compensate or adjust measurements made by each geophysical sensor (122 in FIG. 3) in response to energy emitted by the source (117 in FIG. 3) based on the change in longitudinal position of each geophysical sensor (122 in FIG. 3). Elongation of the streamer in the axial direction may be calculated using a formula based on Young's modulus, for example. One such formula may be expressed as follows:

$$E = \frac{tensile stress}{tensile strain} = \frac{σ}{ɛ} = \frac{F / {A}_{0}}{Δ L / {L}_{0}} = \frac{{FL}_{0}}{{A}_{0} Δ L} \qquad ( 1 )$$

in which E is the Young's modulus (modulus of elasticity) of the streamer, F is the force applied to the streamer, A₀ is the original cross-sectional area of the streamer through which the force is applied, ΔL is the amount by which the length of the streamer changes, and L₀ is the original length of the streamer. Typically the elongation, (ΔL−1)*L₀ would be measured as a function of applied force, F, and then a proportionality constant would be derived which effectively would be A₀*E.

At times during, before, and/or subsequent to conducting a geophysical survey, the streamer monitoring system 200 may be calibrated. For example, spectral measurements may be taken of the FBG sensors 132 under known elongation, bend, and twist conditions. By measuring and recording the wavelengths of the backscattered light from each FBG sensor under known conditions, changes to the wavelengths can be more accurately assessed to determine bend and other physical characteristics of the fiber optic component. Also, by calibrating at multiple times, non-transitory changes to any of the FBG sensors may be monitored. The baseline of the streamer setup may therefore be identified and monitored in order to understand the un-deflected configuration, and to better capture the deflections.

Fiber optic component 130 may be used to measure and/or monitor elongation, bend, and twist at different points along streamer 120. As shown in FIG. 6, FBG sensors 132J, 132K, 132L may be distributed throughout a cross-section of streamer 120. “Distributed throughout a cross-section” refers to being located at different radial distances from the axis 121 of streamer 120, and/or being located at different angular displacements about axis 121 of streamer 120, while being located at nearby axial distances (e.g., no more than 100×grating period Λ). As previously discussed, a fiber optic component 130 may be positioned along streamer 120 in a variety of configurations. In some configurations, a single fiber optic component 130 may wrap around the axis 121 of the streamer 120, such that multiple FBG sensors 132 within the single fiber optic component 130 are distributed throughout a cross-section of streamer 120. In some configurations, multiple fiber optic components 130 may be positioned along streamer 120, such multiple FBG sensors 132—each from a different fiber optic component 130—are distributed throughout a cross-section of streamer 120. In some configurations, there may be a combination of wrapped fiber optic components and multiple fiber optic components such that multiple FBG sensors 132—some from the same fiber optic component and some from different fiber optic components—are distributed throughout a cross-section of streamer 120.

With FBG sensors 132J, 132K, 132L distributed throughout a cross-section of streamer 120, the bend of the axis 121 of streamer 120 may be measured or monitored by streamer monitoring system 200. For example, a bend of the axis of streamer 120 over fold line 240 may cause elongation of FBG sensor 132J, shortening of FBG sensor 132K, and no change of FBG sensor 132L, thus affecting the periodicity of each FBG sensor 132 by changing the spacing between the elements of the grating. As a result, the wavelength of light that is backscattered by each FBG sensor 132 will be correspondingly affected. Thus, a measurement corresponding to the bend of the axis 121 of the streamer 120 may be made at one or more individual axial positions (corresponding to the cross-section having FBG sensors 132J, 132K, 132L) by measuring wavelength of the backscattered light and comparing the changes in adjacent and/or nearby FBG sensors.

Likewise, with FBG sensors 132J, 132K, 132L distributed throughout a cross-section of streamer 120, the twist of the streamer 120 about of the axis 121 may be measured or monitored by streamer monitoring system 200.

In some embodiments, streamer monitoring system 200 may be integrated with the recording system 112, so that streamer characteristic data may be integrated with geophysical data. Streamer characteristic data may include spectral data from interrogated FBG sensors, measurements of elongation of a streamer in the axial direction, measurements of bending of an axis of a streamer, measurements of twisting of a streamer about its axis, temperature data from FDTS sensors, and/or determinations of physical characteristics of at least a portion of a streamer. In some embodiments, if geophysical data from the geophysical sensors is sampled at a certain frequency, the streamer monitoring system may collect streamer characteristic data at the same frequency. The location of geophysical sensors may be coordinated with the locations of FBG sensors and/or FDTS sensors. In some embodiments, the streamer characteristic data may be directly fed into data processing of the geophysical data as an auxiliary channel. For example, processing of the geophysical data may be enhanced with dynamic and online compensation for elongation of the streamer in the axial direction, bending of the axis of the streamer, and/or twisting of the streamer about its axis. This may improve the accuracy of the data, as the elongation, bend, and/or twist measurement may be made in close vicinity to and/or proximate to the geophysical data acquisition electronics.

The FBG sensors 132 may be multiplexed serially in at least one embodiment. For instance, a fiber optic component 130 may contain a plurality of discrete FBG sensors 132 distributed at locations along its length. The fiber optic component 130 may contain several hundred or several thousand of discrete FBG sensors 132, depending on the length of the fiber optic component 130 and the desired distance between the FBG sensors 132. A light source 134, for example a narrowband swept laser, may interrogate the FBG sensors 132 as they respond to strain resulting from stress or pressure on the streamer 120. The shape and movement of the fiber optic component 130 (and therefore the shape and movement of the streamer 120) may be displayed in response. The light source 134 may include a laser source of distribution, multiplexed laser light. In some embodiments, the light source comprises a distributed feedback laser. Also, in some such embodiments, the light source comprises a tunable laser, a fiber laser, or any other narrow linewidth laser source. A carrier frequency may be added to the light using an optical phase modulator driven by a frequency synthesizer.

In some embodiments, FDTS sensors may be used in conjunction with the FBG sensors. FDTS systems are optoelectronic devices which measure temperatures by means of optical fibers, for example, functioning as linear sensors. FDTS systems may be, for example, based on Raman scattering or Brillouin scattering. FDTS sensors may be at locations distributed along the length of a fiber optic component, and may provide a direct method of measuring changes in temperature proximate the locations. Temperatures may be recorded at points or as a continuous profile. A high accuracy of temperature determination may be achieved over great distances. The FDTS systems may locate the temperature to a spatial resolution of about 1 m with accuracy to within about ±1° C. at a resolution of about 0.01° C. FDTS may allow for temperature measurement along at least a portion of the length of a streamer. Typical FDTS systems may provide monitored measurement distances of as much as 30 km or more, and some FDTS systems may have a maximum sensing length of about 100 km.

In some embodiments, the FBG sensors 132 may measure streamer characteristic data in near-real time. For example, one or more of the FBG sensors 132 may measure elongation, bend, and/or twist proximate the locations of the FBG sensors distributed along the fiber optic component 130, positioned along the streamer 120. The system may sample the FBG sensors 132 at a rate of between about 100 and about 5,000 samples per second.

A streamer monitoring system as disclosed herein may determine physical characteristics of a streamer proximate multiple measurement locations in near-real time while the geophysical survey system operates. For example, the FBG sensors 132 may gather elongation, bend, and/or twist measurements while the geophysical sensors 122 gather geophysical data. In at least one embodiment, streamer characteristic data can be displayed in near-real time as the streamer 120 is towed. From these measurements, the streamer monitoring system can be used to calculate the three-dimensional shape, stress, temperature, pressure, strength, stiffness (bending and torsion), and/or operational load, among others. In some embodiments, near-real time determination of physical characteristics of a portion of a streamer may indicate that certain operational action steps should be taken. For example, a determination that a portion of a streamer is subject to excessive operational load may indicate that the survey vessel speed should be slowed, and/or that the streamer should be inspected and cleaned. Alternatively, a determination that a portion of a streamer is subject to unexpectedly minimal operation load may indicate that a streamer break has occurred, and that streamer inspection is warranted. In some embodiments, a streamer monitoring system includes a library of characteristic data signatures representing certain operational conditions, such as streamer damage. For instance, a persistent bend or twist signature may indicate damage at a certain location of the streamer.

In some embodiments, the information from the streamer monitoring system may be used in conjunction with other information about the shape of streamers and/or position of geophysical sensors. For example, the information from the streamer monitoring system may be used supplementally with an acoustic positioning system. Exemplary methods and systems for determining streamer array geometry may be found in U.S. Patent Application 2016/0054466, which is incorporated herein by reference.

In some embodiments, the information from the streamer monitoring system may be used in conjunction with other information about the local motions and/or vibrations along a streamer. For example, noise caused by streamer vibration may be otherwise modeled and modulated in geophysical data. Exemplary methods and systems for attenuating noise in geophysical data may be found in U.S. Patent Application 2016/0109594, which is incorporated herein by reference.

In some embodiments, the disclosed fiber optic monitoring adds only one optical fiber to a conventional streamer. In some embodiments, even a plurality of optical fibers adds negligible weight or volume to that of a conventional streamer. For example, in some embodiments, a single optical fiber may have a diameter of between about 0.5 mm and about 2 mm. In some embodiments, existing fiber optic components in or on a streamer (such as conventionally used to communicate telemetry data as disclosed in U.S. Pat. No. 6,850,461, which is incorporated herein by reference) can be modified to include FBG sensors 132. Thus, there may be minimal change to drag, and the towing speed may be relatively unchanged. Utilizing fiber optic streamer monitoring, near-real time information may be obtained, and a desired acquisition speed can be maintained based on tension information, desired depth can be maintained based on pressure information, and a desired streamer shape can be maintained, among others.

In some embodiments, the streamer monitoring system may provide information regarding the surrounding body of water, such as temperature, pressure, and/or density. This information may be useful in determining and/or adjusting the buoyancy of the streamers or other marine survey equipment.

In accordance with a number of embodiments of the present disclosure, a geophysical data product may be produced. The geophysical data product may include, for example, geophysical data from geophysical sensors and streamer characteristic data, such as spectral data from interrogated FBG sensors, measurements of elongation of a streamer in the axial direction, measurements of bending of an axis of a streamer, measurements of twisting of a streamer about its axis, temperature data from FDTS sensors, and/or determinations of physical characteristics of at least a portion of a streamer. The geophysical data and/or streamer characteristic data may have been previously collected by seismic sensors, electromagnetic sensors, depth sensors, location sensors, FBG sensors, FDTS sensors, etc. The geophysical data and/or streamer characteristic data may be obtained (e.g., retrieved from a data library, collected during a survey, etc.) and may be recorded on a non-transitory, tangible computer-readable medium. The geophysical data product may be produced by processing the geophysical data and/or streamer characteristic data (i.e. by equipment on a vessel) or onshore (i.e. at a facility on land) either within the United States or in another country. If the geophysical data product is produced offshore or in another country, it may be imported onshore to a facility in the United States. In some instances, once onshore in the United States, geophysical analysis, including further data processing, may be performed on the geophysical data product. In some instances, geophysical analysis may be performed on the geophysical data product offshore.

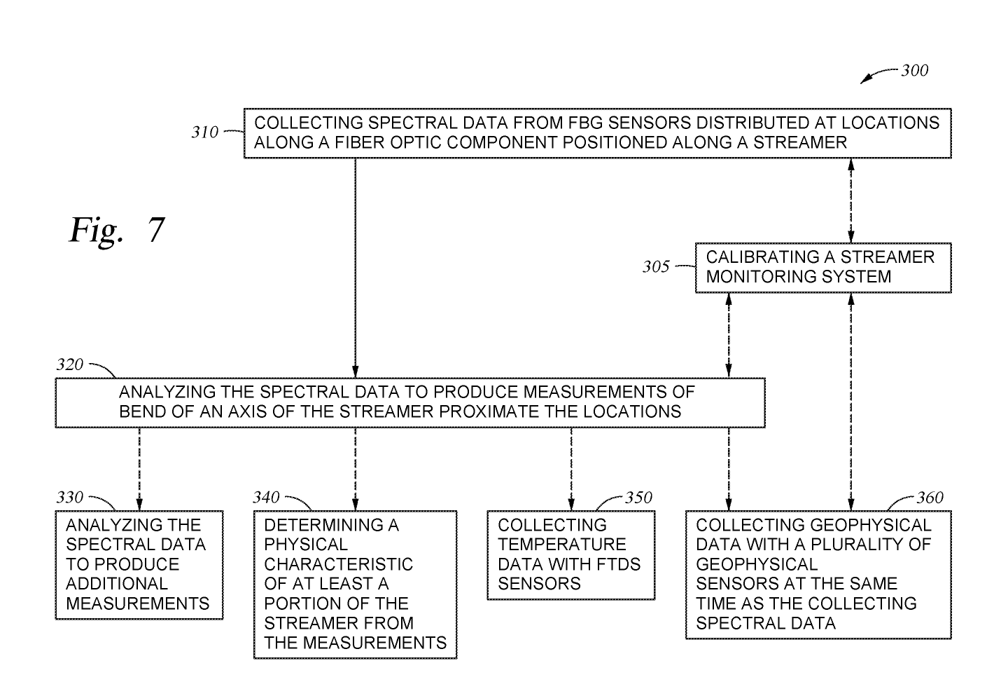

As illustrated in FIG. 7, methods of fiber optic streamer monitoring may involve a number of steps. In some embodiments, a method 300 begins at step 310 by collecting spectral data from FBG sensors distributed at locations along a fiber optic component positioned along a streamer. In some embodiments, the analyzing the spectral data occurs in near-real time. The method 300 continues at step 320 by analyzing the spectral data to produce measurements of bend of an axis of the streamer proximate the locations. The streamer may thereby be monitored by viewing, sampling, or otherwise interpreting the bend measurements. As previously discussed, some operations may also include calibrating a streamer monitoring system during, before, and/or subsequent to conducting a geophysical survey. This optional step is illustrated at step 305. As previously discussed, some operations may also include viewing, sampling, or otherwise interpreting additional measurements. Method 300 may optionally include step 330, analyzing the spectral data to produce additional measurements. In some embodiments, the additional measurements may include at least one of: elongation of the streamer in an axial direction proximate the locations along the fiber optic component; and twist of the streamer about the axis proximate the locations along the fiber optic component. As previously discussed, interpreting the bend measurements may include determining a physical characteristic of at least a portion of the streamer. Method 300 may optionally include step 340, determining a physical characteristic of at least a portion of the streamer from the measurements. In some embodiments, method 300 may further optionally include taking operational action steps in response to determining the physical characteristic. For example, if the physical characteristic that is determined is high strain at a point on the streamer, the action step may be to slow the towing speed. As previously discussed, some operations may also include collecting, analyzing, viewing, sampling, or otherwise interpreting temperature measurements. Method 300 may optionally include step 350, collecting temperature data with FDTS sensors. For example, the FDTS sensors may be at FDTS locations distributed along the length of a FDTS fiber optic component positioned along the streamer. As previously discussed, some operations may also include collecting, analyzing, viewing, sampling, or otherwise interpreting geophysical data. Method 300 may optionally include step 360, collecting geophysical data with a plurality of geophysical sensors at the same time as the collecting spectral data. For example, the plurality of geophysical sensors may be at a plurality of longitudinal positions along the streamer. In some embodiments, a geophysical data product may be generated with the spectral data and the measurements. In some embodiments, the geophysical data product may be recorded on a non-transitory, tangible computer-readable medium suitable for importing onshore. In some embodiments, geophysical analysis may be performed onshore on the geophysical data product.

In an embodiment, a method includes collecting spectral data from fiber Bragg grating sensors distributed at locations along a fiber optic component positioned along a streamer; and analyzing the spectral data to produce measurements of bend of an axis of the streamer proximate the locations.

In one or more embodiment disclosed herein, the method also includes analyzing the spectral data to produce measurements of at least one of: elongation of the streamer in an axial direction proximate the locations along the fiber optic component; and twist of the streamer about the axis proximate the locations along the fiber optic component.

In one or more embodiment disclosed herein, the method also includes determining a physical characteristic of at least a portion of the streamer from the measurements.

In one or more embodiment disclosed herein, the method also includes taking operational action steps in response to determining the physical characteristic.

In one or more embodiment disclosed herein, the analyzing the spectral data occurs in near-real time.

In one or more embodiment disclosed herein, the method also includes collecting temperature data with fiber optic distributed temperature sensing (FDTS) sensors at FDTS locations distributed along a length of a FDTS fiber optic component positioned along the streamer.

In one or more embodiment disclosed herein, the method also includes collecting geophysical data with a plurality of geophysical sensors at a plurality of longitudinal positions along the streamer at the same time as the collecting spectral data.

In one or more embodiment disclosed herein, the method also includes towing the streamer through a body of water.

In one or more embodiment disclosed herein, the method also includes generating a geophysical data product with the spectral data and the measurements.

In one or more embodiment disclosed herein, the method also includes recording the geophysical data product on a non-transitory, tangible computer-readable medium suitable for importing onshore.

In one or more embodiment disclosed herein, the method also includes performing geophysical analysis onshore on the geophysical data product.

In one or more embodiment disclosed herein, the method also includes calibrating a streamer monitoring system, wherein the streamer monitoring system comprises: the fiber Bragg grating sensors; a light source optically coupled to the fiber optic component and configured to interrogate the fiber Bragg grating sensors; a photodetector optically coupled to the fiber optic component and configured to collect the spectral data from the interrogated fiber Bragg grating sensors; and a spectral analyzer in communication with the photodetector and configured to analyze the spectral data.

In an embodiment, a streamer monitoring system includes: a fiber optic component positioned along a streamer; a plurality of fiber Bragg grating sensors distributed at locations along the fiber optic component; a light source optically coupled to the fiber optic component and configured to interrogate the fiber Bragg grating sensors; a photodetector optically coupled to the fiber optic component and configured to collect spectral data from the interrogated fiber Bragg grating sensors; and a spectral analyzer in communication with the photodetector and configured to analyze the spectral data to produce measurements of bend of an axis of the streamer proximate the locations along the fiber optic component.

In one or more embodiment disclosed herein, the spectral analyzer is also configured to analyze the spectral data to produce measurements of at least one of: elongation of the streamer in an axial direction proximate the locations along the fiber optic component; and twist of the streamer about the axis proximate the locations along the fiber optic component.

In one or more embodiment disclosed herein, the fiber optic component is positioned along the streamer such that, at a cross-section of the streamer, a first fiber Bragg grating sensor and a second fiber Bragg grating sensor are distributed throughout the cross-section of the streamer.

In one or more embodiment disclosed herein, the streamer monitoring system also includes a second fiber optic component having a second plurality of fiber Bragg grating sensors and positioned along the streamer such that, at a cross-section of the streamer, a first fiber Bragg grating sensor from the fiber optic component and a second fiber Bragg grating sensor from the second fiber optic component are distributed throughout the cross-section of the streamer.

In one or more embodiment disclosed herein, the light source is selected from a group consisting of a coherent light source, a broadband light source, and a narrowband swept laser.

In one or more embodiment disclosed herein, the fiber optic component spans a length of the streamer.

In one or more embodiment disclosed herein, the fiber Bragg grating sensors are distributed at between 0.15 and 0.30 inch intervals along the fiber optic component.

In one or more embodiment disclosed herein, the streamer monitoring system also includes a fiber optic distributed temperature sensing sensor.

In one or more embodiment disclosed herein, the streamer monitoring system also includes a plurality of geophysical sensors at a plurality of longitudinal positions along the streamer.

In one or more embodiment disclosed herein, at least one geophysical sensor is selected from a group consisting of a seismic sensor and an electromagnetic sensor.

In one or more embodiment disclosed herein, the fiber optic component is an optical fiber bundle.

In one or more embodiment disclosed herein, the fiber optic component is a multi-core optical fiber.

In one or more embodiment disclosed herein, at least a portion of the fiber optic component is within the streamer.

In one or more embodiment disclosed herein, the streamer monitoring system also includes an interferometer.

In one or more embodiment disclosed herein, the fiber Bragg grating sensors are multiplexed serially along the fiber optic component.

In an embodiment, a geophysical survey system includes: a plurality of streamers, each streamer comprising: a plurality of geophysical sensors at a plurality of longitudinal positions along the streamer; a fiber optic component positioned along the streamer; and a plurality of fiber Bragg grating sensors distributed at locations along the fiber optic component; a recording system; and a communication channel from one or more of the fiber optic components to the recording system.

In one or more embodiment disclosed herein, the geophysical survey system also includes: a light source optically coupled to the fiber optic components and configured to interrogate the fiber Bragg grating sensors; a photodetector optically coupled to the fiber optic components and configured to collect spectral data from the interrogated fiber Bragg grating sensors; and a spectral analyzer in communication with the photodetector and configured to analyze the spectral data to produce measurements of bend of an axis of the streamers proximate the locations along the fiber optic components.

In one or more embodiment disclosed herein, the communication channel comprises a second fiber optic component optically coupled between the streamer and the recording system.

In one or more embodiment disclosed herein, the recording system is located on a survey vessel.

In one or more embodiment disclosed herein, the survey vessel tows the plurality of streamers.

While the foregoing is directed to embodiments of the present invention, other and further embodiments of the invention may be devised without departing from the basic scope thereof, and the scope thereof is determined by the claims that follow.

1. A method comprising:
collecting spectral data from fiber Bragg grating sensors distributed at locations along a fiber optic component positioned along a streamer; and
analyzing the spectral data to produce measurements of bend of an axis of the streamer proximate to the locations.

2. The method of claim 1, further comprising:
analyzing the spectral data to produce measurements of at least one of:
elongation of the streamer in an axial direction proximate the locations along the fiber optic component; and
twist of the streamer about the axis proximate to the locations along the fiber optic component.

3. The method of claim 1, further comprising determining a physical characteristic of at least a portion of the streamer from the measurements.

4. The method of claim 3, further comprising taking operational action steps in response to determining the physical characteristic.

5. The method of claim 1, wherein the analyzing the spectral data occurs in near-real time.

6. The method of claim 1, further comprising collecting temperature data with fiber optic distributed temperature sensing (FDTS) sensors at FDTS locations distributed along a length of a FDTS fiber optic component positioned along the streamer.

7. The method of claim 1, further comprising collecting geophysical data with a plurality of geophysical sensors at a plurality of longitudinal positions along the streamer at the same time as the collecting spectral data.

8. The method of claim 7, further comprising towing the streamer through a body of water.

9. The method of claim 1, further comprising manufacturing a geophysical data product with the spectral data and the measurements.

10. The method of claim 9, further comprising recording the geophysical data product on a non-transitory, tangible computer-readable medium suitable for importing onshore.

11. The method of claim 9, further comprising performing geophysical analysis onshore on the geophysical data product.

12. The method of claim 1, further comprising calibrating a streamer monitoring system, wherein the streamer monitoring system comprises:
the fiber Bragg grating sensors;
a light source optically coupled to the fiber optic component and configured to interrogate the fiber Bragg grating sensors;
a photodetector optically coupled to the fiber optic component and configured to collect the spectral data from the interrogated fiber Bragg grating sensors; and
a spectral analyzer in communication with the photodetector and configured to analyze the spectral data.

13. A streamer monitoring system comprising:
a fiber optic component positioned along a streamer;
a plurality of fiber Bragg grating sensors distributed at locations along the fiber optic component;
a light source optically coupled to the fiber optic component and configured to interrogate the fiber Bragg grating sensors;
a photodetector optically coupled to the fiber optic component and configured to collect spectral data from the interrogated fiber Bragg grating sensors; and
a spectral analyzer in communication with the photodetector and configured to analyze the spectral data to produce measurements of bend of an axis of the streamer proximate the locations along the fiber optic component.

14. The streamer monitoring system of claim 13, wherein the spectral analyzer is also configured to analyze the spectral data to produce measurements of at least one of:
elongation of the streamer in an axial direction proximate to the locations along the fiber optic component; and
twist of the streamer about the axis proximate to the locations along the fiber optic component.

15. The streamer monitoring system of claim 13, wherein the fiber optic component is positioned along the streamer such that, at a cross-section of the streamer, a first fiber Bragg grating sensor and a second fiber Bragg grating sensor are distributed throughout the cross-section of the streamer.

16. The streamer monitoring system of claim 13, further comprising a second fiber optic component having a second plurality of fiber Bragg grating sensors and positioned along the streamer such that, at a cross-section of the streamer, a first fiber Bragg grating sensor from the fiber optic component and a second fiber Bragg grating sensor from the second fiber optic component are distributed throughout the cross-section of the streamer.

17. The streamer monitoring system of claim 13, wherein the light source is selected from a group consisting of a coherent light source, a broadband light source, and a narrowband swept laser.

18. The streamer monitoring system of claim 13, wherein the fiber optic component spans a length of the streamer.

19. The streamer monitoring system of claim 13, wherein the fiber Bragg grating sensors are distributed at 0.15 and 0.30 inch intervals along the fiber optic component.

20. The streamer monitoring system of claim 13, further comprising a fiber optic distributed temperature sensing sensor.

21. The streamer monitoring system of claim 13, further comprising a plurality of geophysical sensors at a plurality of longitudinal positions along the streamer.

22. The streamer monitoring system of claim 21, wherein at least one geophysical sensor is selected from a group consisting of a seismic sensor and an electromagnetic sensor.

23. The streamer monitoring system of claim 13, wherein the fiber optic component is an optical fiber bundle.

24. The streamer monitoring system of claim 13, wherein the fiber optic component is a multi-core optical fiber.

25. The streamer monitoring system of claim 13, wherein at least a portion of the fiber optic component is within the streamer.

26. The streamer monitoring system of claim 13, further comprising an interferometer.

27. The streamer monitoring system of claim 13, wherein the fiber Bragg grating sensors are multiplexed serially along the fiber optic component.

28. A geophysical survey system comprising:
a plurality of streamers, each streamer comprising:
a plurality of geophysical sensors at a plurality of longitudinal positions along the streamer;
a fiber optic component positioned along the streamer; and
a plurality of fiber Bragg grating sensors distributed at locations along the fiber optic component;
a recording system; and
a communication channel from one or more of the fiber optic components to the recording system.

29. The geophysical survey system of claim 28, further comprising:
a light source optically coupled to the fiber optic components and configured to interrogate the fiber Bragg grating sensors;
a photodetector optically coupled to the fiber optic components and configured to collect spectral data from the interrogated fiber Bragg grating sensors; and
a spectral analyzer in communication with the photodetector and configured to analyze the spectral data to produce measurements of bend of an axis of the streamers proximate the locations along the fiber optic components.

30. The geophysical survey system of claim 28, wherein the communication channel comprises a second fiber optic component optically coupled between the streamer and the recording system.
